(19) United States
(12) Patent Application Publication
(10) Pub. No.: US 2017/0247827 A1
(43) Pub. Date: Aug. 31, 2017

(54) WASHING METHOD WITH INFUSER IN A VERTICAL LOAD WASHING MACHINE (AQUA)

(71) Applicant: MABE, S.A. DE C.V., Santiago de Querétaro (MX)

(72) Inventors: José Alfredo RAMIREZ OLVERA, Santiago de Querétaro (MX); Erick FLORES ISLAS, Santiago de Querétaro (MX); Santiago Alonso PLATAS AMARILLAS, Santiago de Querétaro (MX)

(21) Appl. No.: 15/444,993

(22) Filed: Feb. 28, 2017

(30) Foreign Application Priority Data
Feb. 29, 2016 (MX) MX/A/2016/002637

(51) Int. Cl. D06F 33/02; D06F 13/04; D06F 37/30; D06F 39/00; D06F 35/00; D06F 37/24; D06F 37/40

(52) U.S. Cl. CPC D06F 33/02; D06F 37/24; D06F 13/04; D06F 37/40; D06F 39/003; D06F 39/004; D06F 35/006; D06F 37/304; D06F 2202/085; D06F 2202/10; D06F 2204/065; D06F 2212/02; D06F 2222/00

(57) ABSTRACT

The present invention relates to a washing method for textiles, which prevents the clothes to be washed from becoming disarranged, entangled or knotted by means of an intensive agitating cycle with asymmetric and symmetric agitating cycles in combination with soaking periods thereby achieving optimal washing with low water consumption.

### FIELD OF THE INVENTION

The present invention is related to principles and techniques used in the household appliance industry, particularly relates to a method for easily and optimally performing some routine domestic tasks, more particularly relates to a method of washing textiles by means of a sequence of intensive agitation which comprises asymmetric and symmetric agitation cycles, and which is further combined with soak intervals to achieve an optimal washing with low water consumption.

### BACKGROUND OF THE INVENTION

Nowadays, consumer demands for better goods are increasing and stricter in the household appliance industry, requiring more modern and aesthetic designs that are cutting edge and have an added value so as to allow some routine domestic tasks to be easily, safely and reliably performed, providing convenience and quickness when performing said tasks.

Among the household appliances, and more particularly white goods, the washing machine is one of those goods that turns out to be essential because it serves to wash clothing, bedding, and linen in general, saving time and effort, but above all, nowadays what is looked for is to increasingly be environment-friendly by mainly decreasing water consumption, using less detergent, optimizing washing cycles and therefore, lower electricity consumption.

There are currently countless types of washing machines such as industrial-, domestic-, vertical (top-loading)-, horizontal (front-loading)-, automatic-, semiautomatic-, manual-, drum-, impeller-, agitator-, roller-, spinning-type washing machines, among others.

Depending on the type of washing machine, there are several washing systems, namely:

European or front-loading system, which uses a drum that rotates first in one direction bringing clothes therewith, and when reached the top, they drop over the water surface. A small pause occurs to allow the detergent to work and the operation is restarted but in a reverse direction. This continuous action of receiving clothes by dropping them over the water is what ends up removing the dirt. The disadvantage of this system is that longer washing cycles are required and therefore, higher electricity consumption.

American or top-loading system, which uses a center agitator having blades that alternately moves the clothes inside the drum, wherein said agitator does not only “agitates” the water, but also rubs the clothes to remove dirt. Such system causes premature wear of clothes, since the damage to clothes is greater than in the other systems; besides requiring high water consumption.

Eastern or propeller system, which uses a propeller or pulsator which is just a disc in the bottom of the basket with small fins that when rotated in different directions and at high speed generates turbulence in the water, twisting clothes, moving them up and down, rubbing them against each other and against the fins and walls of the basket. Such system is very aggressive to the clothes because of the friction on which said washing system is based to remove dirt, besides requiring high water consumption.

Infuser washing system, such system is the newest and uses an infuser that generates water flow currents to remove dirt from the clothes with less friction than a propeller system. Infuser washing machines push the water from the center towards the walls of the basket while moving the clothes from the walls toward the center of the basket, wherein the combination of these actions creates a counterstream, and in turn, water pressure on clothes for cleaning. Also, the infuser has the versatility to be operated from very low levels to high levels of water so that the clothes rub together and/or move through the water to remove dirt particles with an amount of water much lower than in the other systems.

In addition to this, it is well known that conventional automatic washing machines have in common excessive water use, coming to use 200 liters or more per a single load in high capacity washing machines, wherein the water is not used efficiently and consequently, a great waste of this essential liquid is generated. Also, said washing machines use a system of propellers or agitators which, due to their shape, need a large amount of water, since they require a high water level inside the drum to be able to perform the washing action.

Nowadays, any washing machine comprises a sequence of steps or phases: phases of washing, rinsing, and dehydrating by centrifugation. Said phases can be repeated according to the user's selection, the more repeated cycles the better results in cleaning said textiles, which has the disadvantage of excessive use of water for best results.

As already mentioned, the repeated use of washing and rinsing cycles does not allow water savings, because once these cycles are performed, the water used is disposed to be able to start a new washing or rinsing cycle, below are examples of known washing cycles.

U.S. Pat. No. 7,263,862 B2, Lyu et al., discloses a washing method by means of agitation generated by rotationally moving an inner tub and a pulsator in the same direction at an identical speed, wherein subsequently said inner tub and said pulsator rotate in a first direction for a first period of time, wherein said inner tub and said pulsator rotate in a second direction reverse to the first direction for a second predetermined period of time. These movements force or push the textiles against a wall of the inner tub and force the washing water in the inner tub to pass through the textiles and then to pass through the holes provided to the outer tub, and to flow upwardly through a space provided between the inner tub and the outer tub so that the water is recirculated again into the inner tub. However, said washing method always rotates both the inner tub and the pulsator in the same direction.

Meanwhile U.S. Pat. No. 7,376,997 B2 discloses a rinse control method for a washing machine using smaller amount of washing water, through movement or rotation of the inner tub at a relatively high speed. In addition, the direction of rotation of the inner tub in the several washing steps may be opposite to the direction of rotation of the first step.

Several efforts have been made for the purpose of reducing consumption of water and energy in household washing machines, for example, U.S. Pat. No. 4,986,093, Pastryk et al., discloses a recirculation system, which is provided with a tank being mechanically attached to the washer's tub, said tank receives the detergent or chemicals as well as a predetermined amount of water, the tank serves to mix the detergent with chemicals so that they are sprayed onto the items to be washed. This solution has the disadvantage of using large amounts of water for the washing cycle, that is, said washing cycle is performed in a traditional way, namely: the tub is filled to a certain water level, whereby the items to be washed are completely submerged in said liquid, afterwards the agitation cycle begins, with the variant that before said agitation, the mixture or washing liquid contained in the tank is pumped to a nose or shower spraying said wash liquor onto the items to be washed. As can be seen, said method and arrangement of the tank do not contribute greatly to substantial water and energy savings.

Document EP 668 389, Kretchman et al., presents a space being located between the bottom of the basket and the bottom of the tub and being used to store water, once a certain level of liquid is reached in said zone, detergent or washing chemicals are added while mixing to form washing liquid, said washing liquid is extracted by means of a pump placed in a trough and hoses to be sprayed through the top of the basket, while the bottom of the basket rotates with one or two degrees of freedom.

Mexican Patent 324,880 (US 2011-099726), assigned to the assignee of the present application, discloses a washing method comprising the following sequences: checking a water level, performing a load pre-sensing sequence, subsequently performing a reshuffling agitating sequence, performing a load sensing sequence, determining the water level required to admit; once said water level is reached, a normal agitation sequence is begun, which if during its course, a clog of items to be washed or unusual high density thereof is detected, a high density washing sequence may be begun, or where appropriate, an agitation sequence at maximum load; once said normal agitation sequence is finished, a load reshuffling sequence takes place in order to continue with the dehydrating and subsequent rinsing. However, said document does not disclose that a water saving is achieved due to the washing sequence and that the effect of washing liquids is improved with a consequent increase in washing efficiency.

According to the aforementioned, it is easy to identify and see a great variety of machines and methods that exist in the prior art for washing textiles, which generally use paddles or propellers in combination with movements of drum or inner hub to achieve agitation and/or water flow currents that move the clothes thus generating the mechanical action of scrubbing clothes, said mechanical action further causes rubbing or friction between the blades or propellers and the textiles, creating a greater damage. Therefore, there is still a need in the art for textile washing processes that do not damage excessively clothes being washed.

For properly washing, a balance is required between the different energies used or concurring in a washing process, namely, the first energy is the chemical energy of the washing liquid, the second energy is the mechanical energy exerted by the agitator or infuser on the clothes, and the fluid flow currents that cause the wash liquid to pass through the fibers and the scrubbing itself between textiles; the third energy is the thermal energy that is the temperature of water and/or washing liquid in which the clothes or items to be washed are submerged. The interaction between these energies along with the washing time causes an effective washing cycle to take place or not. Thus, the result of washing or washability depends on the balance of said 3 energies as well as the washing time.

Some types of washing machines have jeopardized the stain removal performance due to the small amount of water used, which renders the washing cycle a bit effective by having to use more time or more repetitions of said washing cycle, or by having to use any means to raise the water temperature, (a process that in turn consumes high amounts of energy) in order to enhance the chemical power of detergents or other additives added to water to form the washing liquid.

These known washing cycles, in order to achieve an acceptable washability or washing efficiency, require high amounts of energy or a very robust drive system, which in turn requires high amounts of energy, which in turn increases the product cost as well as the cost per washing cycle due to its high energy consumption.

Moreover, in a household washing machine, which comprises a basket, a motor, a power transmission, and an agitating element or means, in a preferred embodiment, said agitating element or means may preferably be of the infuser type, due to its particular mode of operation, the clothes tend to agglomerate or become entangled. It has been shown that the absence of a correct agitation pattern or sequence during the washing cycle, the relative movement between said agitating element or means and said basket, due to this unsuitable agitation, the items to be washed become disarranged, entangled or knotted, which accelerates their wear as they can be subjected to stress during agitation or centrifugation when fibers thereof are softened by the effect of water and washing liquid. Thus, there is a need for clothes to not be subjected to such wearing processes during the washing. Moreover, the automatic reshuffling of clothes inside the basket at the end of the agitating phase is important because the absence of said reshuffling of clothes could cause an unsuitable operation of the washing machine due to unbalancing during the spinning that is performed during centrifugation.

As can be seen, there is still a need in the art for developing methods of washing textiles which allow to maintain considerable savings in water and energy, and which also allow a low deterioration level of textiles to be achieved.

### BRIEF DESCRIPTION OF THE INVENTION

As mentioned, for a higher-efficiency washing, a correct combination and balance of the energies involved during this process is required. It has been found that by changing the way in which the mechanical function of agitation is carried out in a washing machine during the washing cycle, along with the means for scrubbing or agitating (blades, infusers, etc.), the washing quality can be optimized and thereby avoiding excessive wear or premature deterioration of the garments or textiles that are undergoing a washing in a machine, while the effect of detergents or washing liquid is increased. Thus, significantly reduced levels of washing water consumption are achieved, maintaining the user's washing efficiency expectations. For these purposes, the present washing method has been developed, wherein said method uses more efficiently mechanical and chemical energies of washing liquid(s). It is an object of the present invention to increase the load of chemical energy and lower gas consumption of mechanical and thermal energies. Thus, the washing cycle further incorporates a series of soaking or resting cycles without mechanical activity, increasing the activity time of washing chemicals. By increasing the time of action of washing chemicals (detergents or washing liquids) with the garments, a consequent reduction in the consumption of mechanical and/or thermal energy normally used is achieved, thus allowing very good garment care results to be obtained, avoiding premature wear of said garments with high performance and efficiency in removing dirt. This is achieved by implementing the following washing process, which alternately integrates washing steps and resting steps. Thus, it has been shown that the effectiveness of a conventional washing machine can be greatly improved if the soaking time of the textiles with detergent or washing liquid increases. By means of this washing procedure, cleaning of textiles is achieved as well as homogeneous removal of stains from clothing during the washing process allowing an efficient use of water consumption.

The cycle begins when the operator has introduced a certain amount of items to be washed into a washing machine, optionally, a certain amount of washing additives, has selected a program to be used in the same and the washing machine has been started, said washing machine can initiate a load pre-sensing sequence, then perform a reshuffling sequence, and subsequently a washing sequence. Once washing has been performed, said washing machine performs the drain of used water with or without centrifugation, subsequently a rinsing sequence and finally, a clothes drying sequence can take place. In the present invention, each of the washing steps or sequences is accompanied by at least one soaking or resting step, where no friction is generated or no mechanical energy is used in the clothes, only the chemical-action effect of detergents or washing liquid takes place. In addition, the rinsing blocks or the required rinsing profile may also carry a resting profile between each scrubbing or agitating sequence. In order to save water a washing process has been designed, wherein said washing process allows the action of detergents to be improved by allowing more time in contact with the clothes instead of performing multiple washing sequences with load and change of additional water. In addition to this, each washing sequence comprises agitating the agitating element in a specific agitating sequence or pattern. The agitating pattern for washing may be asymmetrical or symmetrical or a combination thereof as described below so as to avoid subjecting the garments to friction and in turn avoid the clothes to become entangled or knotted inside the washing tub or basket during the washing process.

Thus, the present invention relates to a method of washing textiles that can be carried out in a washing machine comprising: a rotating basket that is drivable by a driving system; agitating means arranged inside said rotating basket and operable by said driving system; an electronic control system; and means for determining the position of either said rotating basket or said agitating means; the method comprising:

by means of said electronic control system,

determining a load size for washing;

determining a water level inside said washing tub;

performing a washing sequence which comprises:

an intensive agitating sequence comprising rotating said agitating means in a controlled manner to cause agitation on said load for washing for a certain time;

monitoring the number of rotations of said agitating means;

the method being characterized in that said intensive agitating sequence comprises rotating said agitating means in a first rotational direction for a first predetermined time period and then rotating it in a second rotational direction opposite to said first rotational direction for a second predetermined time period, wherein said first and second predetermined time periods of rotation are set to make an agitating pattern symmetric and asymmetric; and further comprises stopping the rotation of said agitating means after completing each symmetrical and/or asymmetric agitating pattern for a predetermined time period, to cause an additional soaking of the washed clothes.

The invention relates and is directed to specific embodiments in the appended claims.

The invention also relates to a washing machine that can implement the washing method.

### BRIEF DESCRIPTION OF THE DRAWINGS

FIG. 1 depicts a cross section of a washing machine in which the method of the present invention can be implemented.

FIG. 2 depicts a flowchart of the high efficiency washing method of the present invention.

### DETAILED DESCRIPTION OF PREFERRED EMBODIMENTS

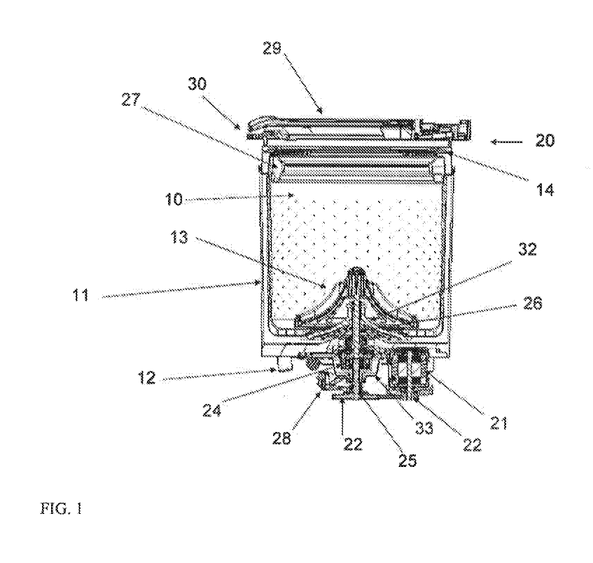

A washing machine that implements the present invention is illustrated in FIG. 1 and is the top-loading or vertical axis type, having a cabinet (not shown) to which four suspension bars 12 are attached, said suspension bars support the weight of the tub 11 along with other accessories to said cabinet, besides acting as a damper of vibrations that originate due to the washing process, thus the tub 11 is hanging from said suspension bars. Over said tub 11, the remaining peripheral equipment is mounted, such as a motor 21. In a preferred embodiment, a planetary gear 24 for reduction can be used, which allows to adjust the relationship between pulleys 22, thus the pulley 22 with the greatest diameter will be adjusted over an inner shaft 25 which will receive power from said electric motor 21, thanks to the pulley arrangement 22 and the belt. In a preferred embodiment, said shaft 25 at its upper end is coupled to said planetary gear 24 to reduce the angular velocity and thus obtaining higher torque, an exit shaft of said planetary gear 24 reintegrates into said shaft 25, which on its upper end has an agitating means 13 arranged which in a preferred embodiment of the invention is an infuser 13. In an alternative embodiment, said inner shaft 25 on its lower end is coupled to said pulley 22 with the greatest diameter, and on its upper end is coupled to said agitating means 13. A hollow shaft 26 houses in its interior said inner shaft 25; said hollow shaft 26 is mechanically coupled to a clutch 28 by a cover 33, said clutch can cause both arrows 25 and 26 to rotate together or independently, also said hollow shaft 26 is mechanically coupled to the center of a basket 10 or to a hub 32, so that when shafts 25, 26 are clutched and rotating together, said hollow shaft 26 will transmit power to said basket 10 so that it may rotate together with said agitating means 13. The washing machine further comprises a main cover 30 as well as a washing machine door or lid 29.

Additionally, said basket 10 can be crowned by a balancing ring 27 which counteracts the unbalancing caused by the shifting inside said basket 10 of the items to be washed. The tub itself has assembled unto its upper end a tub cover 14 which houses a grid as well as a spray deflector (not shown), the cabinet in turn is covered by the main cover which covers the upper part of the washing machine 20, said main cover helps support electric components such as an electronic control, drivers, a pressure switch, etc., which are usually placed in a crown (not shown).

The electronic control along with the several sensors or actuators which it controls, allows the correct operation of said washing machine 20 by sending signals to the several actuators at the times determined by the subject method of the present invention, thus said electric motor 21 is energized by a driver which receives signals from the electronic control, said electronic control sends a pulse of certain length to said driver so that it, during the time said pulse length lasts, energizes said motor 21 in a direction; the same occurs to energize said motor 21 in the opposite direction, waiting for a predetermined time between swats or pulse widths. The technician in the art may determine the means necessary to suitably control the movement of a motor in both directions.

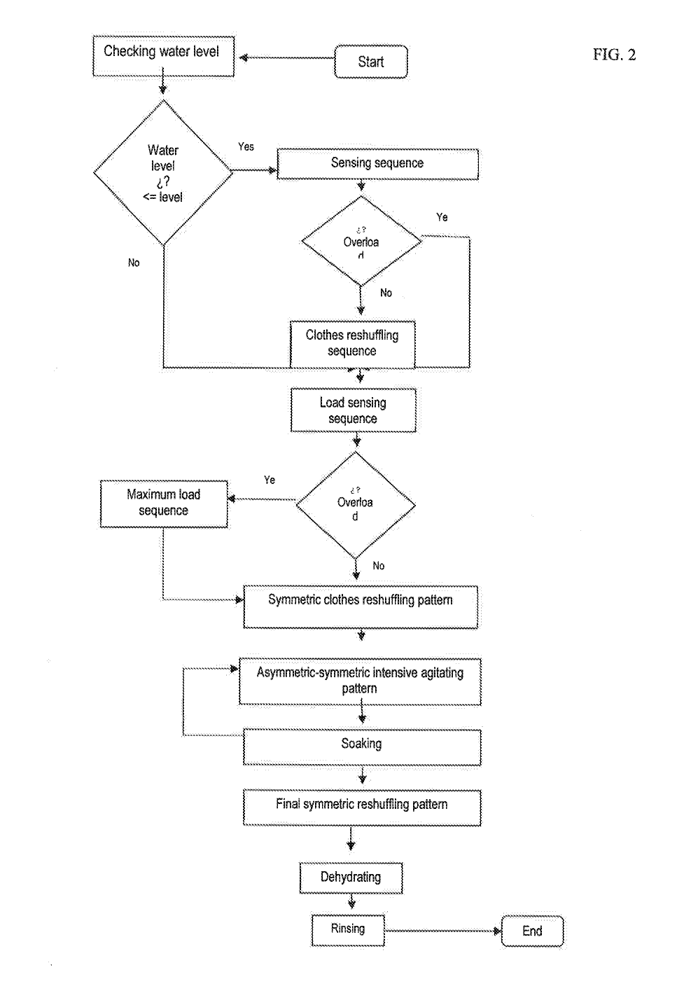

The subject high efficiency washing method of the present invention can be explained with reference to FIG. 2, the cycle begins when the operator has introduced a predetermined amount of items to be washed, optionally a predetermined amount of washing additives to form a washing liquid or detergents, has selected the program to be used and has started the washing machine.

The washing method of the present invention, which improves the washing, can usually be carried out by using a mechanical agitating means or element 13, such as an infuser, agitator, impeller, blades or any other means to perform the mechanical function of agitation, combining features of this type of washing systems with the textile's soaking during washing, which provides the necessary or additional time for washing agents, washing liquids or detergents to be able to suitably react with the clothes which are being washed, unlike a continuous scrubbing or agitation.

Thus, the washing method of the present invention provides a washing sequence with scrubbing or agitation of clothes and an intermediate rest for a predetermined time, which is called soak. This intermediate rest time between each washing or scrubbing sequence can be automatically or selectively preset and/or programmed by an operator, taking into consideration parameters of the load, type of clothes and dirt contained.

The scrubbing sequence of garments has also been modified over the normal sequence in conventional washing machines, in which the agitating element or means is rotated in one direction, or optionally the agitating element and the tub, but ultimately achieving only the rotation in one direction. In some system it can be seen that rotation is done in two directions but symmetrically, i.e., one spin in the clockwise direction (clockwise, CW), and another spin in the opposite direction or counterclockwise, (counterclockwise, CCW). This behavior of the agitating element rotation causes the clothes to become entangled and knotted between each other, thereby causing the clothes to suffer premature wear, as they are under stress while being scrubbed or agitated by the agitating means or element. Thus, the applicant has surprisingly found that to prevent the clothes from becoming entangled during the washing in a washing machine, the spin(s) or relative movement of the agitating element should not be in one direction or symmetrical spins only as used conventionally. Thus, the assignee of the present invention has found that clothes do not become entangled or knotted while being washed by performing asymmetric rotation patterns of the agitating means or element, or achieving relative movement between the agitating means or element and the washing tub. Additionally, said asymmetric agitating pattern performed during an intensive washing sequence, in combination with soaking periods, achieves maximum washing efficiency.

The asymmetric agitating pattern can be combined or further interposed with reshuffling patterns comprising previous or final symmetric rotations, which has been shown to be effective to avoid the clothes to become knotted between each other while being washed with this method.

The asymmetric movement or rotation, or asymmetric agitating pattern of said agitating element or means is achieved by rotating it in two different rotating directions or achieving relative movement thereof, the movement can be relative to the washing basket 10, starting with a movement in the CW direction, and subsequently in the CCW direction. Additionally, a third movement in the CW direction can be generated. The symmetric movement of the agitator is achieved only by rotating it in opposite directions, CW and CCW, the same number of times in both directions.

The amount of rotations or movements necessary to achieve asymmetric or symmetric patterns can be controlled by the electronic controller, and can range from a section of arc to more than one full rotation. A symmetric agitating pattern in a preferred embodiment may comprise a full rotation in each direction.

In an alternative embodiment, an asymmetric rotation comprises two rotations in one direction.

In a more preferred embodiment, the asymmetric agitating pattern comprises two rotations in one direction and three rotations in another direction. For example, two CW rotations and three CCW rotations, or vice versa.

The symmetric agitating pattern may also comprise one section of rotation to more than one full rotation, preferably two rotations in the same direction, for example, two CW rotations or two CCW rotations. Thus, a symmetric agitating pattern comprises rotating or moving the agitating element in only two directions for the same number of times symmetrically.

Thus, the washing process of a garment consists of rotating the agitating element in a first symmetric agitating pattern, subsequently rotating it in the asymmetric agitating pattern, or vice versa. In one embodiment, agitating patterns can be done wherein more than one continuous agitating pattern is interposed.

The washing process further includes repeating said patterns more than once. Additionally, resting or soaking times are interposed between scrubbing or washing patterns. Soaking times can be interposed between each agitating pattern. The waiting or resting time can be configured for the controller to be able to keep the motor inactivated from a minimum time to a maximum time. In a preferred embodiment, the resting times can be up to one minute. In an alternative embodiment, the controller can be set for the soaking time to be 2, 3, 5, 8 and up to 15 minutes.

The resting period allows the detergent or cleaning additives forming the washing liquid to react with the garments in order to i) begin softening the fibers of said garments, ii) soften stains or dirt that otherwise would need an excessive washing time which would prematurely damage said garment or would cause said garment to be subjected to repeated washing cycles with consequent waste of water and energy.

The agitating pattern may have different configurations and embodiments, in a preferred embodiment, agitation is configured to keep turning for a given time, rather than a predetermined number of rotations or spins. Thus, an agitating pattern can comprise performing a symmetric agitating pattern for a first predetermined time, then an asymmetric agitating pattern for another predetermined time. Agitating times may be different between each other.

For example, a washing pattern would comprise rotating the agitating means for sufficient time to achieve swat(s) necessary to achieve, for example, rotations in one direction, and rotating it in the same way in the opposite direction to achieve the asymmetric pattern for another predetermined time either longer or shorter.

In a preferred embodiment, a washing cycle comprises 1) a symmetric clothes reshuffling pattern, then an intensive agitating pattern comprising: a) at least one asymmetric intensive agitating pattern, b) a soaking period, c) a symmetric intensive agitating pattern, d) a soaking period, and e) a final symmetric reshuffling pattern.

Additionally, the washing cycle can comprise: determining the load size for washing; determining a water level inside the washing tub; supplying water and stopping said water supply; one or more spinning sequences, and at least a rinsing sequence. A load determining sequence may comprise an overload detection and a washing pattern at maximum load if overload is detected.

Such sequences may be in this order or a different order, and repeated.

Initial and final symmetric reshuffling patterns comprise at least one rotation, and after them a soaking period can take place.

The preferred asymmetric agitating pattern comprises an agitating block of n CW rotations and m CCW rotations or vice versa, wherein n is different from m. Said agitating pattern can be repeated as necessary and can be adjusted to washing patterns depending on the type of garments to be washed. Similarly, the number of rotations required to achieve an asymmetric pattern can be 1-2, 2-3, 3-2, etc. Preferably, n is 2 and m is 3. Symmetric agitating patterns may comprise at least one rotation.

In a further preferred embodiment, the washing cycle comprises applying 1 to 11 agitating patterns interposing asymmetric and symmetric agitating patterns, which in turn are interposed with resting periods.

Soaking times of the garments which are interposed between each agitating pattern can comprise times ranging from one minute to 8 minutes or more, for example 15 minutes, if the operator determine to do so based on the items to be washed.

Thus, a whole washing cycle can be represented as and can comprise the following agitating patterns listed in Table 1 below:

TABLE 1
Satisfactory washing sequence

| Initial reshuffling | Intense agitating | Final reshuffling |
|---|---|---|
| pattern | pattern | pattern |
| Symmetric | 1. Asymmetric | Symmetric |
| | 2. Soaking | |
| | 3. Symmetric | |
| Symmetric | Asymmetric CC + CCW or | Symmetric |
| CC or CCW | CCW + CC | CC or CCW, |
| | Symmetric CC or CCW | |

asymmetric intensive agitating blocks, wherein the first rotating direction is longer than the second rotating direction and a second short intensive agitating block, wherein the first rotating direction is shorter than the second rotating direction. It has been shown that if such patterns of short and long intensive agitating patterns are interposed during the washing cycle, the garments become disarranged, entangled or knotted in a relatively lesser degree than in conventional washing cycles, wherein the rotating direction is in one direction or in both directions but symmetrical.

An arrangement of intensive washing cycle that has shown surprising effects on the reshuffling of the clothes is the following set of 11 blocks:

i. 1 short asymmetric agitating block

ii. 1 symmetric agitating block

iii. 1 short asymmetric agitating block

iv. 1 symmetric agitating block

v. 1 short asymmetric agitating block

vi. 1 long asymmetric agitating block

vii. 1 symmetric agitating block

viii. 1 long asymmetric agitating block

ix. 1 symmetric agitating block

x. 1 long asymmetric agitating block

xi. 1 symmetric agitating block

Each block is followed by a soaking period, and as previously mentioned, by an initial and final symmetric reshuffling block.

Additionally, the washing method comprises a rinsing sequence, which may comprise any of the asymmetric and symmetric agitating patterns previously described, to also avoid disarrangement during this stage.

It has been further shown that depending on the hemisphere where the washing machine is located, it is necessary to switch the agitating cycles to avoid disarrangement, entangling or knotting of the clothes to be washed, so that the person skilled in the art could make adjustments necessary for this. It has also been shown that in Northern Hemisphere it is necessary to finish with an asymmetric reshuffling pattern and in Southern Hemisphere it is necessary to finish with a symmetric reshuffling pattern.

Any variation or modification may be made to the above described embodiments of the invention without departing from the scope of the invention as defined in the following claims.

Likewise, said variations and modifications are intended to be included within the scope of the present invention as set forth in the appended claims.

1. A washing method for textiles comprising carrying out in a washing machine comprising:
a washing basket;
an agitating means arranged inside said washing basket the sequences of:
a. at least one washing sequence comprising:
i) at least one intensive agitating sequence comprising rotating said agitating means to cause agitation on a washing load for a predetermined time;
said method is characterized in that said intensive agitating sequence comprises rotating said washing basket or said agitating means relative to each other, in a first rotating direction for a first predetermined time or a first predetermined rotation amount, and subsequently in a second rotating direction opposite to said first rotating direction, for a second predetermined time or a second predetermined rotation amount, and
wherein said first or second predetermined time of rotation or said first and second predetermined rotation amount are configured to make a symmetric and asymmetric agitating pattern.

2. The washing method for textiles of claim 1, characterized by further comprising relatively stopping the rotation of said washing basket or said agitating means after completing each symmetric and/or asymmetric agitating pattern for a predetermined time to cause soaking of the garments to be washed.

3. The washing method for textiles of claim 2, characterized by further comprising the step of performing a symmetric or asymmetric reshuffling pattern.

4. The washing method for textiles of claim 3, characterized in that said symmetric or asymmetric reshuffling pattern is performed before said intensive agitating sequence.

5. The washing method for textiles of claim 4, characterized in that said symmetric or asymmetric reshuffling pattern is performed after said intensive agitating sequence.

6. The washing method for textiles of claim 5, characterized in that said symmetric or asymmetric reshuffling pattern comprises rotating said agitating means relative to said washing basket at least one rotation in two rotating directions.

7. The washing method for textiles of claim 6, characterized in that soaking is performed after said symmetric or asymmetric reshuffling pattern.

8. The washing method for textiles of claim 7, characterized in that said asymmetric agitating pattern comprises an agitating block of n CW rotations and m CCW rotations or vice versa, wherein n is different from m.

9. The washing method for textiles of claim 8, characterized in that said asymmetric agitating pattern comprises a short asymmetric agitating pattern, wherein n<m or a long asymmetric agitating pattern wherein n>m.

10. The washing method for textiles of claim 9, characterized in that n is 2 and m is 3.

11. The washing method for textiles of claim 9, characterized in that said intensive agitating sequence comprises at least one short asymmetric agitating pattern and at least one long asymmetric agitating pattern.

12. The washing method for textiles of claim 11, characterized in that said intensive agitating sequence comprises at least three short asymmetric agitating patterns and at least three long asymmetric agitating patterns.

13. The washing method for textiles of claim 12, characterized in that three short asymmetric agitating patterns are firstly performed and then said three long asymmetric agitating patterns.

14. The washing method for textiles of claim 13, characterized in that at least one symmetric agitating block is interposed between said short asymmetric agitating patterns and said long asymmetric agitating patterns.

15. The washing method for textiles of claim 13, characterized in that no symmetric agitating block is interposed after said short asymmetric agitating patterns.

16. The washing method for textiles of claim 14, characterized in that said symmetric agitating pattern comprises an agitating block of n CW rotations and n CCW rotations.

17. The washing method for textiles of claim 16, characterized in that said symmetric agitating pattern comprises an agitating block of at least one rotation.

18. The washing method for textiles of claim 17, characterized by further comprising the steps of:
determining a load size for washing;
determining a water level inside a washing tub;
supplying water and stopping said water supply;
at least one spinning sequence, and
at least one rinsing sequence.

19. The washing method for textiles of claim 18, characterized in that said rinsing sequence comprises an intensive agitating sequence.

20. The washing method for textiles of claim 19, characterized in that said agitating means is selected from an infuser, an agitator, propeller or paddles.

21. The washing method for textiles of claim 20, characterized in that said agitating means comprises an infuser.

22. The washing method for textiles of claim 21, wherein said washing machine further comprises a rotating basket and a driving system or means.

23. The washing method for textiles of claim 22, wherein said washing machine further comprises means for determining the position and controlling the driving system of either said washing basket or said agitating means.

24. The washing method for textiles of claim 23, wherein said means for determining the position and controlling the driving system comprise an electronic control system.

25. The washing method for textiles of claim 23, wherein said means for determining the position and controlling the driving system further monitor the rotation amount or rotation time of said agitating means or said washing basket.
